(19) United States
(12) Patent Application Publication
(10) Pub. No.: US 2003/0104834 A1
(43) Pub. Date: Jun. 5, 2003

(54) Mobile phone call receiving device capable of automatically turning off car stereo

(76) Inventor: Mao-Shen Wang, Hsintien City (TW)

Correspondence Address: TROXELL LAW OFFICE PLLC, SUITE 1404, 5205 LEESBURG PIKE, FALLS CHURCH, VA, 22041, US

(21) Appl. No.: 10/001,955

(22) Filed: Dec. 5, 2001

(51) Int. Cl. H04M 1/00

(52) U.S. Cl. 455/557; 455/567; 455/569

(57) ABSTRACT

Mobile phone call receiving device capable of automatically turning off car stereo for a user to safely use the mobile phone when driving. The device includes: a main frame for sensing a radio-frequency signal input by the mobile phone and sending out a carrier signal and an extension which according to the carrier signal turns off the car stereo or silences the car stereo. When receiving a mobile phone call, the device is able to turn off the car stereo or silence the car stereo so that a user can concentratively use the mobile phone without minding turning off or silencing the car stereo.

### BACKGROUND OF THE INVENTION

The present invention is related to a mobile phone call receiving device capable of automatically turning off car stereo. When receiving a mobile phone call, the device is able to turn off the car stereo or silence the car stereo so that a user can concentratively safely use the mobile phone without minding turning off or silencing the car stereo.

A conventional hold-free device for mobile phone includes a holder in which the mobile phone is fixedly held. The output is amplified by an external speaker. On the other hand, a microphone is used to input the voice of a user for communication. Such hold-free device serves to ensure safety in using the mobile phone when driving. However, when receiving a mobile phone call, a user still needs to turn off the car stereo or turn down the volume of the car stereo. Therefore, the user can hardly concentratively use the mobile phone. This may result in danger when driving.

### SUMMARY OF THE INVENTION

It is therefore a primary object of the present invention to provide a mobile phone call receiving device capable of automatically turning off car stereo for a user to safely use the mobile phone when driving. The device includes: a main frame for sensing a radio-frequency signal input by the mobile phone and sending out a carrier signal and an extension which according to the carrier signal turns off the car stereo or silences the car stereo.

The main frame includes: a mobile phone high frequency sensing amplifier which via an antenna senses and amplifies the radio-frequency signal sent out by the mobile phone; a microprocessor coupled with the mobile phone high frequency sensing amplifier for calculating the time of radio-frequency signal, whereby when the radio-frequency signal lasts for over 3 seconds, the microprocessor sends out an oscillation control signal; a carrier oscillation circuit coupled with the microprocessor, whereby when receiving oscillation control signal, the carrier oscillation circuit sends out a carrier oscillation signal; a power plug coupled with the carrier oscillation circuit for transmitting the carrier oscillation signal via an ACC power wire; a choke coil coupled with the power plug for choking the carrier oscillation signal of the power plug to output D.C. power; a stabilizing circuit coupled with the choke coil for stabilizing the D.C. power and then outputting the D.C. power; an amplifier for amplifying the mobile phone earphone signal input; and an output plug coupled with the amplifier for externally connecting with a speaker for outputting audiofrequency signal.

The extension includes: a carrier filter coupled with the ACC power wire for filtering carrier oscillation signal; a high frequency choke filter circuit coupled with the ACC power wire for choking the carrier oscillation signal to provide D.C. p power; an amplifier coupled with the carrier filter for amplifying the carrier oscillation signal; a wave detector coupled with the amplifier for detecting a half-period carrier oscillation signal; a driving amplifier coupled with the wave detector for amplifying the half-period carrier oscillation signal; and an interrupter coupled with the high frequency choke filter circuit, the driving amplifier and a silencing input wire, whereby when the half-period carrier oscillation signal appears, the interrupter cuts off the ACC power wire to turn off the car stereo or grounds the silencing input wire to silence the car stereo.

The present invention can be best understood through the following description and accompanying drawings wherein:

### BRIEF DESCRIPTION OF THE DRAWINGS

FIG. 1A shows that the present invention is connected with an earphone plug;

FIG. 1B shows that the present invention is connected with the microphone of the mobile phone and the transmitter is externally connected with a pickup;

FIG. 2 is a block diagram of the main frame of the present invention;

FIG. 3 is a block diagram of the extension of the present invention;

FIG. 4 is a circuit diagram of the main frame of the present invention; and

FIG. 5 is a circuit diagram of the extension of the present invention.

### DETAILED DESCRIPTION OF THE PREFERRED EMBODIMENTS

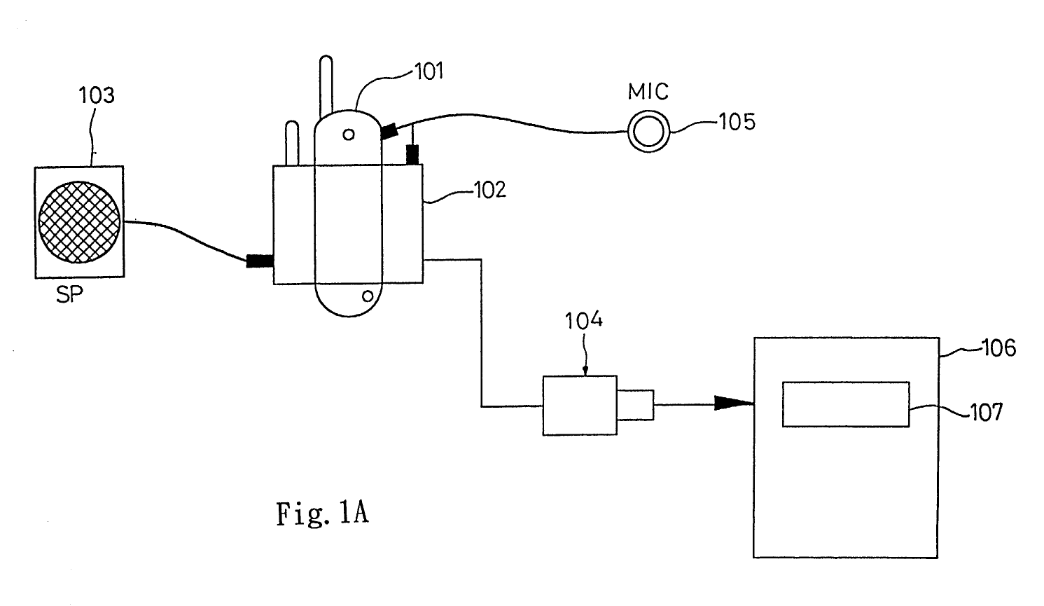

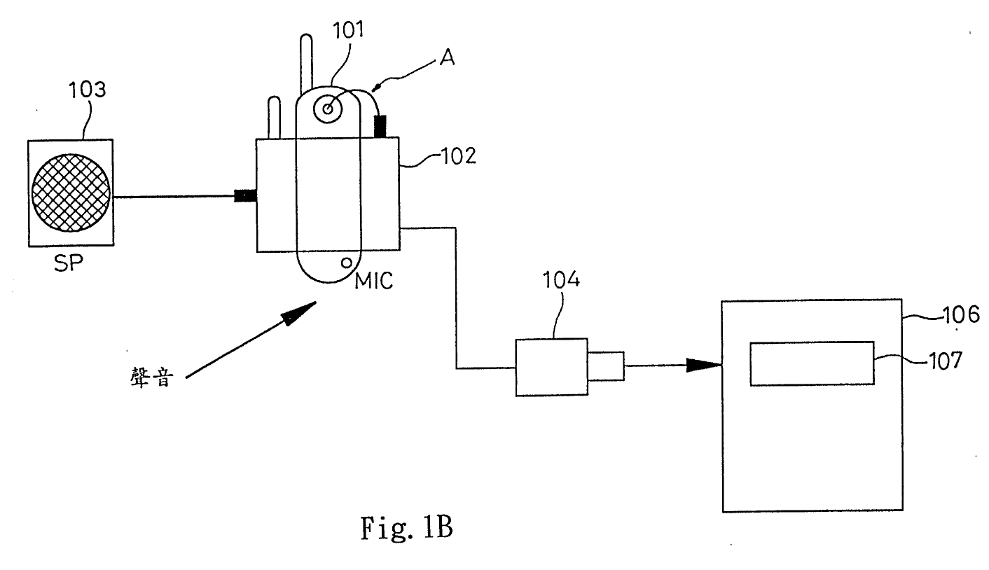

Please refer to FIG. 1A which shows that the present invention is connected with an earphone. A user can place a mobile phone 101 in the receiving space of the main frame 102 of the present invention. Also, the external speaker 103 is connected to the main frame 102. The power plug 104 is plugged into the lighter socket of the car. Via an ACC power wire, the carrier signal is transmitted to the extension 107 in the car stereo 106. The caller voice signal of the earphone plug is connected to the input plug on the main frame 102 to be output by the external speaker 103. When the mobile phone 101 receives a call, the antenna of the main frame 102 can sense the high frequency signal emitted from the antenna of the mobile phone 101 and send out a 27 MHz carrier oscillation signal to ACC power wire. When the extension 107 senses the carrier signal, it cut off the power of the car stereo 106 or silence the car stereo 106. Accordingly, the user can talk via the microphone without minding turning off or silencing the car stereo 106.

Please refer to FIG. 1B which shows that the present invention is connected with the microphone of the mobile phone and the transmitter is externally connected with a pickup. A user can also input speech via the microphone of the mobile phone 101. The pickup picks up the voice signal of the caller and connects the voice signal to the input plug of the main frame 102 to be output from the external speaker 103 to achieve the function of FIG. 1A.

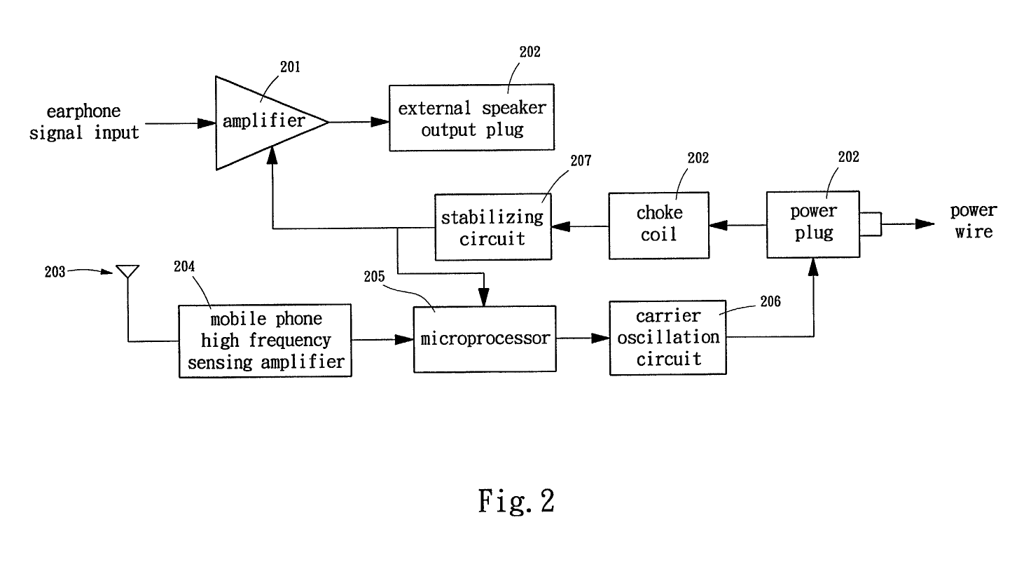

FIG. 2 shows a block diagram of the main frame of the present invention. The main frame includes: a mobile phone high frequency sensing amplifier 204 which via the antenna 203 senses and amplifies the radio-frequency signal sent out by the mobile phone 101; a microprocessor 205 coupled with the mobile phone high frequency sensing amplifier 204 for calculating the time of radio-frequency signal, when the radio-frequency signal lasts for over 3 seconds, the microprocessor 205 sending out an oscillation control signal; a carrier oscillation circuit 206 coupled with the microprocessor 205, when receiving oscillation control signal, the carrier oscillation circuit 206 sending out a 27 MHz carrier oscillation signal; a power plug 209 coupled with the carrier oscillation circuit 206 for transmitting the carrier oscillation signal via the ACC power wire; a choke coil 208 coupled with the power plug 209 for choking the carrier oscillation signal to output D.C. power; a stabilizing circuit 207 coupled with the choke coil 208 for stabilizing the D.C. power and then outputting the D.C. power; an amplifier 201 for amplifying the mobile phone voice signal input; and an output plug 202 coupled with the amplifier 201 for externally connecting with a speaker for outputting audiofrequency signal.

The exchanging signal between the mobile phone and the base station will last for about 2 seconds. Therefore, after the mobile phone high frequency sensing amplifier 204 via the antenna 203 senses the radio-frequency signal sent out by the mobile phone 101, the amplifier 204 amplifies the signal and sends the signal to the microprocessor 205 for processing. After the microprocessor 205 receives the radio-frequency signal, it starts to calculate the time. In the case that the radio-frequency signal only lasts for two seconds, this means the radio-frequency signal is the exchanging signal which is ignored. In the case that the radio-frequency signal lasts for over three seconds, this means there is a mobile phone call. The microprocessor 205 will transmit a 27 MHz carrier oscillation signal via the ACC power wire. In this embodiment, the carrier oscillation signal is 27 MHz. However, it is not limited to this frequency and the carrier oscillation signal with other frequency is included in the range of the present invention.

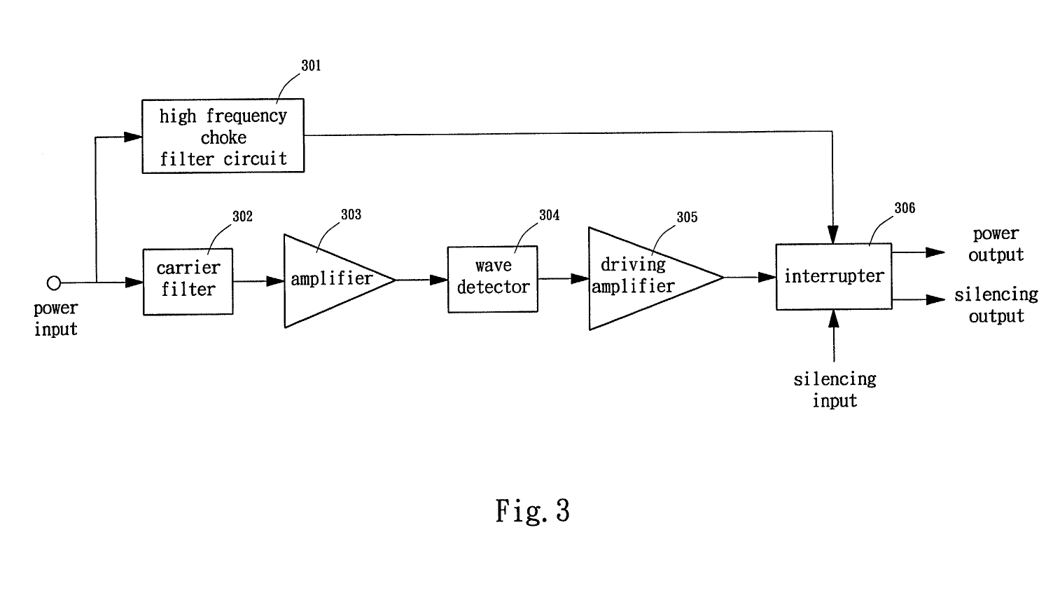

FIG. 3 shows a block diagram of the extension of the present invention. The extension includes a carrier filter 302 coupled with the ACC power wire for filtering carrier oscillation signal, a high frequency choke filter circuit 301 coupled with the ACC power wire for choking the carrier oscillation signal to provide D.C. power, an amplifier 303 coupled with the carrier filter 302 for amplifying the carrier oscillation signal, a wave detector 304 coupled with the amplifier 303 for detecting a half-period carrier oscillation signal, a driving amplifier 305 coupled with the wave detector 304 for amplifying the half-period carrier oscillation signal and an interrupter 306 coupled with the high frequency choke filter circuit 301, driving amplifier 305 and a silencing input wire. When the half-period carrier oscillation signal appears, the interrupter 306 cuts off the ACC power wire to turn off the car stereo or grounds the silencing input wire to silence the car stereo.

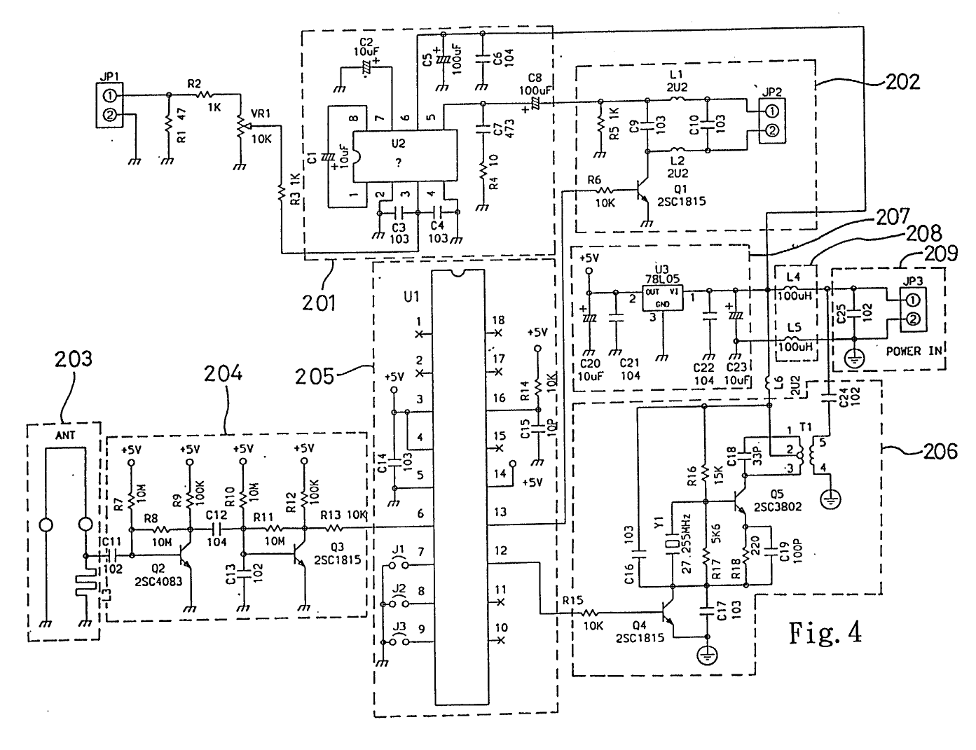

FIG. 4 shows the circuit diagram of the main frame of the present invention, in which the blocks enclosed by the phantom lines are denoted by the same reference numerals as FIG. 2. The operation of the main frame is as follows: After the antenna 203 senses the radio-frequency signal sent out by the mobile phone 101, the signal is sent to the mobile phone high frequency sensing amplifier 204 which amplifies the signal and then sends the signal to the microprocessor 205 for processing. The microprocessor 205 calculates the lasting time of the radio-frequency signal. In the case that the radio-frequency signal only lasts for two seconds, this means the radio-frequency signal is the exchanging signal which is ignored. In the case that the radio-frequency signal lasts for over 3 seconds, this means there is a mobile phone call. Under such circumstance, the microprocessor 205 sends out an oscillation control signal to the carrier oscillation circuit 206. After receiving the oscillation control signal, the carrier oscillation circuit 206 sends out a 27 MHz carrier oscillation signal to the power plug 209 which transmits the carrier oscillation signal via the ACC power wire.

The power plug 209 is also connected to the lighter socket of the car for supplying power for the present invention. As shown in FIG. 4, the choke coil 208 is coupled with the power plug 209 for choking the carrier oscillation signal and sending the signal to the stabilizing circuit 207 for stabilization. Thereafter, a D.C. power is output to supply power for the present invention.

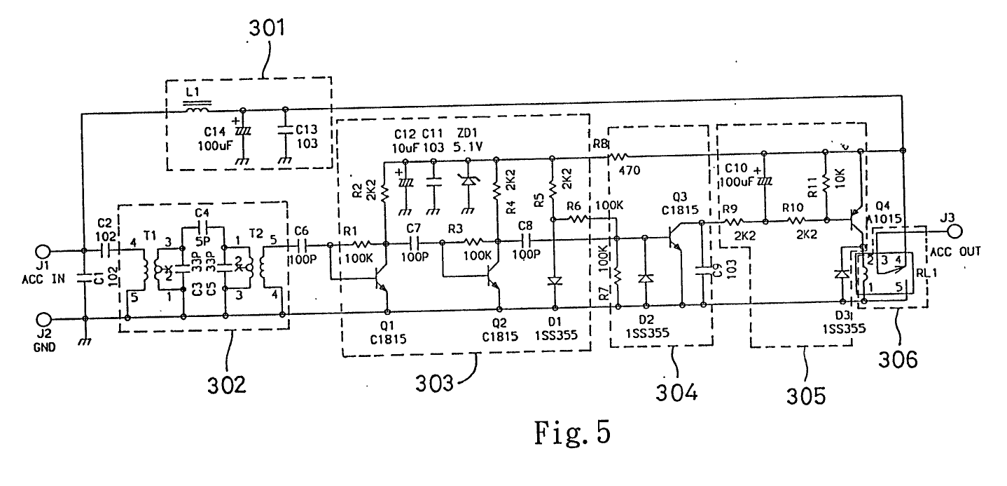

FIG. 5 shows the circuit diagram of the extension of the present invention, in which the blocks enclosed by the phantom lines are denoted by the same reference numerals as FIG. 3. The operation of the main frame is as follows: The carrier oscillation signal carried by the ACC power wire is at the same time input to the high frequency choke filter circuit 301 and the carrier filter 302. The high frequency choke filter circuit 301 chokes the carrier oscillation signal and restores it into original ACC power and sends it to the interrupter 306. Also, the carrier filter 302 filters the ACC power of the carrier oscillation signal and restores it into original carrier oscillation signal and sends it to the amplifier 303 for amplification. The wave detector 304 detects the amplified half-period carrier oscillation signal. The driving amplifier 305 amplifies the half-period carrier oscillation signal and sends it to the interrupter 306 to open the relay in the interrupter 306 for controlling the ACC power so as to turn off the car stereo. Alternatively, the relay in the interrupter 306 for controlling the silencing input is grounded so as to silence the car stereo.

The above embodiments are only used to illustrate the present invention, not intended to limit the scope thereof. Many modifications of the above embodiments can be made without departing from the spirit of the present invention.

What is claimed is:

1. Mobile phone call receiving device capable of automatically turning off car stereo for a user to safely use the mobile phone when driving, the device comprising:
a main frame for sensing a radio-frequency signal input by the mobile phone and sending out a carrier signal; and
an extension which according to the carrier signal turns off the car stereo or silences the car stereo.

2. Device as claimed in claim 1, wherein the main frame includes:
a mobile phone high frequency sensing amplifier which via an antenna senses and amplifies the radio-frequency signal sent out by the mobile phone;
a microprocessor coupled with the mobile phone high frequency sensing amplifier for calculating the time of radio-frequency signal, whereby when the radio-frequency signal lasts for over 3 seconds, the microprocessor sends out an oscillation control signal;
a carrier oscillation circuit coupled with the microprocessor, whereby when receiving oscillation control signal, the carrier oscillation circuit sends out a carrier oscillation signal;
a power plug coupled with the carrier oscillation circuit for transmitting the carrier oscillation signal via a power wire;
a choke coil coupled with the power plug for choking the carrier oscillation signal of the power plug to output D.C. power;
a stabilizing circuit coupled with the choke coil for stabilizing the D.C. power and then outputting the D.C. power;
an amplifier for amplifying the mobile phone earphone signal input; and
an output plug coupled with the amplifier for externally connecting with a speaker for outputting audiofrequency signal.

3. Device as claimed in claim 1, wherein the carrier oscillation signal is 27 MHz.

4. Device as claimed in claim 1, wherein the extension includes:
a carrier filter coupled with the ACC power wire for filtering carrier oscillation signal;
a high frequency choke filter circuit coupled with the ACC power wire for choking the carrier oscillation signal to provide D.C. power;
an amplifier coupled with the carrier filter for amplifying the carrier oscillation signal;
a wave detector coupled with the amplifier for detecting a half-period carrier oscillation signal;
a driving amplifier coupled with the wave detector for amplifying the half-period carrier oscillation signal; and
an interrupter coupled with the high frequency choke filter circuit, the driving amplifier and a silencing input wire, whereby when the half-period carrier oscillation signal appears, the interrupter cuts off the ACC power wire to turn off the car stereo or grounds the silencing input wire to silence the car stereo.
